(19) United States
(12) Patent Application Publication
(10) Pub. No.: US 2019/0168709 A1
(43) Pub. Date: Jun. 6, 2019

(54) WEBBING TAKE-UP DEVICE

(71) Applicant: KABUSHIKI KAISHA TOKAI-RIKA-DENKI-SEISAKUSHO, Aichi-ken (JP)

(72) Inventor: Atsushi NISHINO, Aichi-ken (JP)

(21) Appl. No.: 16/321,270

(22) PCT Filed: Aug. 3, 2017
(86) PCT No.: PCT/JP2017/028201

§ 371 Date: Jan. 28, 2019

(30) Foreign Application Priority Data
Aug. 12, 2016 (JP) 2016-158951

(51) Int. Cl. B60R 22/405; B60R 22/46

(52) U.S. Cl. CPC B60R 22/405; B60R 22/46

(57) ABSTRACT

A webbing take-up device is provided with a spool that is rotated in a pull-out direction as a result of a webbing of a seatbelt device being pulled out, a sliding contact surface that is provided on a side in a rotation axis direction of the spool, and a locking component that, as a result of the locking component being moved towards a locking side, causes rotation of the spool in the pull-out direction to be restricted, and in which a curved surface portion that bulges towards the sliding contact surface side is provided further toward an inner side than an outer peripheral edge side of the sliding contact surface side, and in which the curved surface portion is made to slide across the sliding contact surface by the movement of the locking component towards the locking side.

### TECHNICAL FIELD

The present disclosure relates to a webbing take-up device that enables rotation of a spool in a pull-out direction to be restricted as a result of a locking component being moved towards a locking side.

### BACKGROUND ART

A webbing tale-up device exists in which, in a vehicle emergency, the rotation of a spool in a pull-out direction is restricted as a result of a locking component of a locking mechanism being moved towards a locking side (see, for example, Japanese Unexamined Patent Application Laid-Open (JP-A) No. H9-277904). In this type of webbing take-up device, the spool-side surface of the locking component comes into contact with a locking base or with the spool. Because of this, when the locking component is moved, if a tilt is generated in the locking component, then an outer peripheral edge of the locking component (namely, a corner portion of the locking component) comes into contact with the locking base or the spool, and this causes friction resistance to be generated between the locking component and the locking base or spool.

### SUMMARY OF THE INVENTION

### Technical Problem

The present disclosure was conceived in view of the above-described circumstances and provides a webbing take-up device that enables friction resistance between a locking component and a sliding contact surface with which the locking component is in sliding contact to be either prevented or inhibited from increasing.

### Solution to the Problem

A webbing take-up device of a first aspect of the present disclosure includes a spool that is rotated in a pull-out direction as a result of a webbing of a seatbelt device being pulled out, a sliding contact surface that is provided at a side, in a rotation axis direction, of the spool, and a locking component that, as a result of the locking component being moved towards a locking side, causes rotation of the spool in the pull-out direction to be restricted. A curved surface portion that bulges towards the sliding contact surface side is provided at an inner side from an outer peripheral edge side at the sliding contact surface side of the locking component, and the curved surface portion is made to slide across the sliding contact surface by the movement of the locking component towards the locking side.

According to the webbing take-up device of the first aspect, a curved surface portion of a locking component is made to slide across a sliding contact surface by a movement of the locking component towards the locking side. Here, the curved surface portion is provided at an inner side from an outer peripheral edge side of the locking component, and this curved surface portion bulges towards the sliding contact surface side. Because of this, even if the locking component does become tilted when the locking component is being moved, the outer peripheral edge of the locking component is inhibited from coming into contact with the sliding contact surface, so that friction resistance between the locking component and the sliding contact surface is either prevented or inhibited from increasing.

In a webbing take-up device of a second aspect of the present disclosure, in the webbing take-up device of the first aspect, the curved surface portion is provided further toward the inner side of the locking component than a portion at the locking side of an outer peripheral edge at the sliding contact surface side of the locking component.

According to the webbing take-up device of the second aspect, the curved surface portion of the locking component is provided further toward the inner side of the locking component than a portion at the locking side of the outer peripheral edge at the sliding contact surface side of the locking component. Because of this, even if the locking component is moved towards the locking side so that, as a result of this movement, the locking component becomes tilted and the locking side of the outer peripheral edge at the sliding contact surface side of the locking component approaches close to the sliding contact surface, the outer peripheral edge of the locking component is inhibited from coming into contact with the sliding contact surface.

A webbing take-up device of a third aspect of the present disclosure, in the webbing take-up device of the first aspect or the second aspect, further comprises an engaging component at which are formed engaging teeth with which locking teeth that are formed at the locking component intermesh as a result of the movement of the locking component towards the locking side, rotation of the spool in the pull-out direction is restricted by the locking teeth intermeshing with the engaging teeth. The curved surface portion is provided further toward the inner side of the locking component than a portion of the locking teeth that is set at an outer peripheral edge at the sliding contact surface side of the locking component.

According to the webbing take-up device of the third aspect, the curved surface portion of the locking component is provided further toward the inner side of the locking component than a portion of the locking teeth, which intermesh with the engaging teeth of the engaging component, at the outer peripheral edge at the sliding contact surface side of the locking component. Because of this, even if the locking component is moved towards the locking side so that the locking teeth of the locking component approach close to the engaging teeth of the engaging component, and so that, as a result of this movement, the locking component is tilted and the portion of the locking teeth at the outer peripheral edge at the sliding contact surface side of the locking component approaches close to the sliding contact surface, the portion of the locking teeth at the outer peripheral edge of the locking component is inhibited from coming into contact with the sliding contact surface.

In a webbing take-up device of a fourth aspect of the present disclosure, in the webbing take-up device of the first aspect through the third aspect, a tilt inhibiting portion is disposed at the locking component at an opposite side, in the spool rotation axis direction, from the sliding contact surface, the locking component is sandwiched between the tilt inhibiting portion and the sliding contact surface, and in a case in which a tilt action is generated at the locking component, the locking component comes into contact with the tilt inhibiting portion so that tilting of the locking component is inhibited.

According to the webbing take-up device of the fourth aspect, a tilt inhibiting portion is provided at the locking component at an opposite side, in the spool rotation axis direction, from the sliding contact surface, and the locking component is sandwiched between the sliding contact surface and the tilt inhibiting portion. If a tilting action is generated at the locking component, the locking component comes into contact with the tilt inhibiting portion and, as a result of this, tilting of the locking component is inhibited. Because of this, even if a tilting action is generated in the locking component so that the portion of the locking teeth at the outer peripheral edge at the sliding contact surface side of the locking component approaches closer to the sliding contact surface, the portion of the locking teeth at the outer peripheral edge of the locking component is inhibited from coming into contact with the sliding contact surface.

In a webbing take-up device of a fifth aspect of the present disclosure, in the webbing take-up device of the fourth aspect, the locking component is moved towards the locking side as a result of the locking component receiving a load at a tilt inhibiting portion side on the opposite side from the curved surface side.

According to the webbing take-up device of the fifth aspect, the locking component is moved towards the locking side as a result of the opposite side of the locking component from the curved surface side receiving a load at the tilt inhibiting portion side. Because of this, although it is easy for a tilting action to be generated in the locking component when the locking component is being moved towards the locking side, even if the locking component does tilt such that the locking side of the outer peripheral edge at the sliding contact surface side of the locking component approaches the sliding contact surface, the outer peripheral edge of the locking component is inhibited from coming into contact with the sliding contact surface due to the curved surface portion being provided at the locking component.

### Advantageous Effects of the Disclosure

As has been described above, in the webbing take-up device according to the present disclosure, friction resistance between the locking component and the sliding contact surface with which the locking component comes into contact is prevented or inhibited from increasing.

### BRIEF DESCRIPTION OF THE DRAWINGS

FIG. 1 is a front cross-sectional view showing the structure of a webbing take-up device according to an exemplary embodiment of the present disclosure.

FIG. 2 is an exploded perspective view of a spool, a locking base, and a locking plate of a webbing take-up device.

FIG. 3A is a front cross-sectional view showing an enlargement of a spool, a locking base, a locking plate, and a V gear, and shows a state prior to the locking plate being rotated.

FIG. 3B is a front cross-sectional view showing an enlargement of a spool, a locking base, a locking plate, and a V gear, and shows a state after the locking plate has been rotated.

### DESCRIPTION OF THE EMBODIMENTS

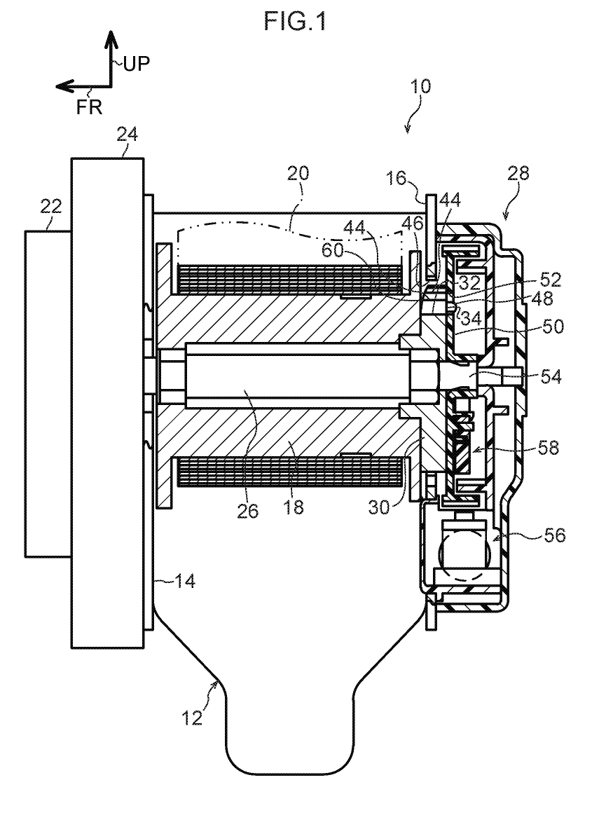

Next, an exemplary embodiment of the present disclosure will be described based on the respective drawings shown in FIG. 1 through FIG. 3. Note that an arrow FR, an arrow OUT, and an arrow UP that are shown in each drawing respectively indicate a front side, an outer side in a vehicle width direction, and an upper side of a vehicle in which a webbing take-up device 10 of the present exemplary embodiment has been applied.

### Structure of the Present Exemplary Embodiment

As is shown in FIG. 1, the webbing take-up device 10 according to the present exemplary embodiment is provided with a frame 12 which serves as an engaging component. The frame 12 is fixed to a vehicle lower side portion of a center pillar (not shown in the drawings) which serves as a vehicle body. Additionally, the frame 12 is provided with leg plates 14 and 16, and the leg plates 14 and 16 face each other substantially in the vehicle front-rear direction.

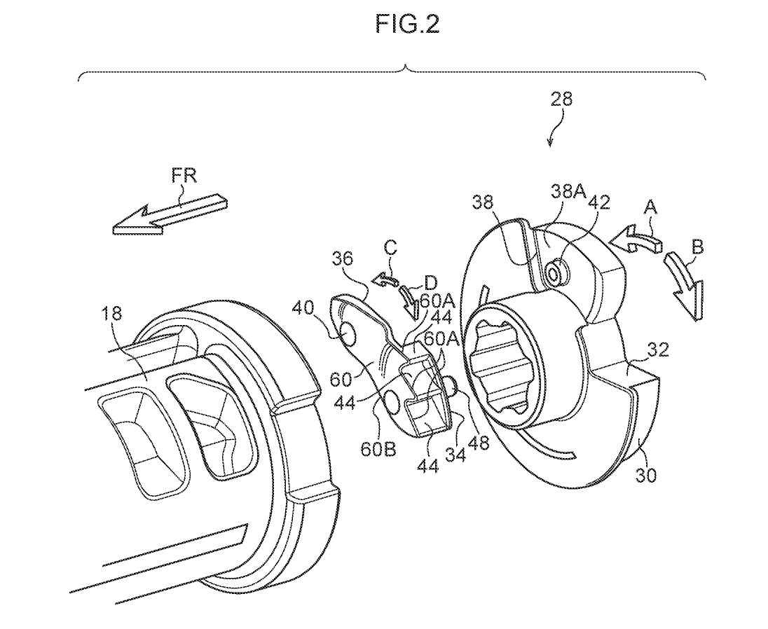

A spool 18 is provided in the frame 12. The spool 18 is formed in a substantially circular cylinder shape. A direction of a central axis of the spool 18 extends in the direction in which the leg plate 14 and the leg plate 16 face each other (in other words, substantially in the vehicle front-rear direction), so that the spool 18 is able to rotate around the central axis thereof. A base end portion in a longitudinal direction of an elongated belt-shaped webbing 20 is anchored to the spool 18, so that when the spool 18 is rotated in a take-up direction (i.e., in the direction shown by an arrow A in FIG. 2), the webbing 20 is taken up by the spool 18 from the base end side in the longitudinal direction thereof. A distal end side in the longitudinal direction of the webbing 20 extends towards the vehicle upper side from the spool 18, and the distal end side in the longitudinal direction of the webbing 20 passes through a slit hole formed in a through anchor (not shown in the drawings) which is supported on the center pillar at the vehicle upper side of the frame 12, and is then folded back towards the vehicle lower side.

Additionally, the distal end portion in the longitudinal direction of the webbing 20 is anchored to an anchor plate (not shown in the drawings). The anchor plate is formed from a metal plate material such as steel or the like, and is fixed to a floor portion (not shown in the drawings) of the vehicle, or to a frame member or the like of a sheet (not shown in the drawings) that corresponds to this webbing take-up device 10.

A vehicle seatbelt device in which the present webbing take-up device 10 is being used is provided with a buckle device (not shown in the drawings). The buckle device is disposed on the inner side in the vehicle width direction of the seat in which the present webbing take-up device 10 is being used. When the webbing 20 has been pulled over the body of a vehicle occupant who is sitting in this seat, a tongue (not shown in the drawings) provided at the webbing 20 is engaged with the buckle device resulting in the webbing 20 being fitted over the body of the vehicle occupant.

As is shown in FIG. 1, a spring housing 22 is provided at the vehicle front side of the leg plate 14 of the frame 12. A spool urging mechanism such as a spiral spring or the like (not shown in the drawings) is provided at an inner side of the spring housing 22, and the spool 18 is urged in the take-up direction by urging force imparted by the spool urging mechanism.

A pretensioner 24 is provided between the leg plate 14 of the frame 12 and the spring housing 22. The pretensioner 24 is operated in the event of a vehicle emergency such as a vehicle collision or the like. When the pretensioner 24 is operated, the spool 18 is rotated in the take-up direction so that the webbing 20 is taken up by the spool 18. As a result, the restraining force restraining the vehicle occupant provided by the webbing 20 is increased.

Additionally, the present webbing take-up device 10 is provided with a torsion bar 26 that forms a force limiter mechanism. The torsion bar 26 is formed in a bar shape that is elongated substantially in the vehicle front-rear direction. A vehicle front-side portion of the torsion bar 26 is disposed at an inner side of the spool 18, and is connected to the spool 18 such that any relative rotation thereof relative to the spool 18 is prevented.

Additionally, the present webbing take-up device 10 is provided with a locking mechanism 28. The locking mechanism 28 is provided with a locking base 30. The locking base 30 is provided at the vehicle rear side of the spool 18 so as to be able to rotate freely around the central axis of the spool 18. A vehicle rear-side portion of the torsion bar 26 is inserted into the locking base 30 so that any relative rotation of the locking base 30 relative to the torsion bar 26 is prevented. As a result of this, the locking base 30 is connected to the spool 18 via the torsion bar 26, so that a relative rotation of the locking base 30 relative to the spool 18 is prevented.

As is shown in FIG. 2, a locking plate placement portion 32 is formed at the locking base 30. The locking plate placement portion 32 is created by forming an opening in a portion of an outer periphery of the locking base 30, so as to form a notch shape that is open on both sides in the vehicle front-rear direction of the locking base 30. A main body portion of a locking plate 34, which serves as a locking component, is disposed at the inner side of the locking plate placement portion 32. A tail portion 36 extends from an end portion on a take-up direction side of the main body portion of the locking plate 34. The tail portion 36 is formed in a plate shape whose thickness dimension (i.e., whose dimension in the vehicle front-rear direction) is smaller than that of the main body portion of the locking plate 34. The tail portion 36 is formed on a spool 18 side (i.e., on the vehicle front side) of a central portion in the thickness direction (i.e., in the vehicle front-rear direction) of the main body portion of the locking plate 34.

A tail portion placement portion 38 is formed at the locking base 30 so as to correspond to the tail portion 36 of the locking plate 34. The tail portion placement portion 38 is formed as a recessed portion that is opened at a vehicle front-side surface of the locking base 30. The tail portion placement portion 38 is created by forming an opening in an outer peripheral portion of the locking base 30, and the tail portion placement portion 38 is connected to the locking plate placement portion 32 on a pull-out direction side (i.e. on the side in the direction indicated by an arrow B in FIG. 2). The dimension in the vehicle front-rear direction of the tail portion placement portion 38 is set either the same as the thickness dimension of the tail portion 36 of the locking plate 34, or slightly larger than the thickness dimension of the tail portion 36.

When the main body portion of the locking plate 34 has been disposed within the locking plate placement portion 32 of the locking base 30, the tail portion 36 is disposed within the tail portion placement portion 38 of the locking base 30. A supporting hole 40 is formed at the tail portion 36. A supporting pin 42 that is formed at the tail portion placement portion 38 protruding towards the vehicle front side is inserted into the supporting hole 40 at the locking plate 34, so that the locking plate 34 is able to pivot around the supporting pin 42.

A portion of the tail portion placement portion 38 that faces the tail portion 36 of the locking plate 34 in the vehicle front-rear direction is formed as an opposing wall 38A which serves as a tilt inhibiting portion. If, due to looseness (i.e., due to a gap) between the supporting hole 40 at the locking plate 34 and the supporting pin 42 at the tail portion placement portion 38, the locking plate 34 becomes tilted so that the direction of the central axis of the supporting hole 40 becomes tilted relative to the direction of the central axis of the supporting pin 42, the locking plate 34 comes into contact with the opposing wall 38A of the tail portion placement portion 38. As a result, the tilting of the locking plate 34 is inhibited.

Moreover, a plurality of locking teeth 44 are formed at the locking plate 34. These locking teeth 44 are formed at an end portion of the main body portion of the locking plate 34 on the opposite side from the tail portion 36. A ratchet hole 46 is formed at the leg plate 16 of the frame 12 so as to correspond to the locking teeth 44. The ratchet hole 46 is formed coaxially with the spool 18, and is provided with ratchet teeth which are internal teeth serving as engaging teeth. When the locking plate 34 is pivoted towards the locking side (i.e., towards the side in the direction indicated by an arrow C in FIG. 2) around the supporting pin 42, the opposite side from the tail portion 36 side of the main body portion of the locking plate 34 is moved towards an outer side in a radial direction of the locking base 30. When, as a result of this, the locking teeth 44 intermesh with the ratchet teeth of the ratchet hole 46 at the leg plate 16, rotation of the locking base 30 in the pull-out direction is restricted.

Additionally, a guide pin 48 is formed at the locking plate 34. The guide pin 48 protrudes towards the vehicle rear side from a vehicle rear-side surface of the main body portion of the locking plate 34. The guide pin 48 is inserted into a guide hole 52 of a V gear 50, which is serving as a rotating body of the locking mechanism 28 and which is provided at a vehicle rear side of the locking base 30. The V gear 50 is supported at a supporting shaft 54 that extends towards the vehicle rear side from a vehicle rear-side end portion of the torsion bar 26, so that the V gear 50 is able to rotate freely coaxially with the spool 18.

A follower spring (not shown in the drawings) is provided between the V gear 50 and the locking base 30, so that the V gear 50 is able to be rotated by urging force from the follower spring following the rotation of the locking base 30. Moreover, the locking base 30 is also able to perform a relative rotation in the pull-out direction relative to the V gear 50 by resisting the urging force of the follower spring. In this way, when the locking base 30 is rotated in the pull-out direction relative to the V gear 50, the guide pin 48 of the locking plate 34 is guided by the guide hole 52 of the V gear 50 so that, as a result of this, the locking plate 34 is pivoted towards the locking side around the supporting pin 42.

In addition, the locking mechanism 28 is provided with a VSIR mechanism 56 and a WSIR mechanism 58. The VSIR mechanism 56 of the locking mechanism 28 is operated, for example, as a result of the vehicle suddenly decelerating during a vehicle collision or the like, and the rotation of the V gear 50 in the pull-out direction is restricted due to the VSIR mechanism 56 being operated. In contrast to this, The WSIR mechanism 58 of the locking mechanism 28 is operated, for example, as a result of a rotation acceleration in the pull-out direction of the V gear 50 reaching a predetermined size or greater, and the rotation of the V gear 50 in the pull-out direction is restricted due to the WSIR mechanism 58 being operated.

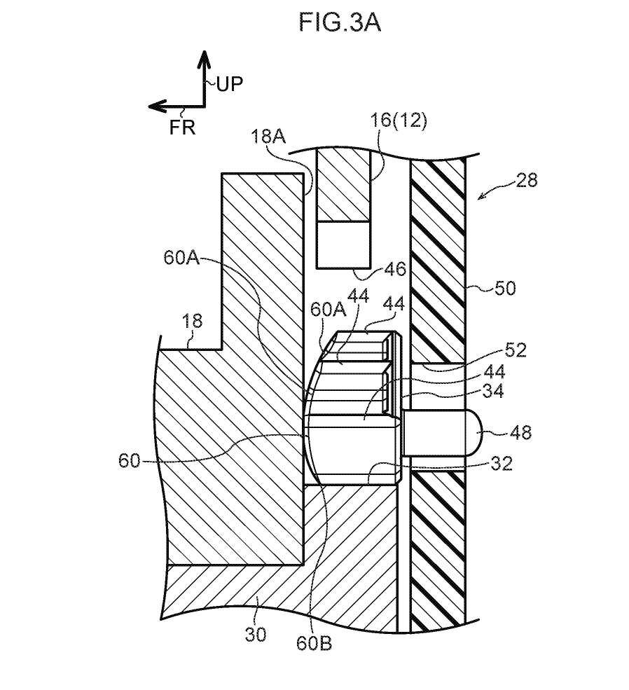

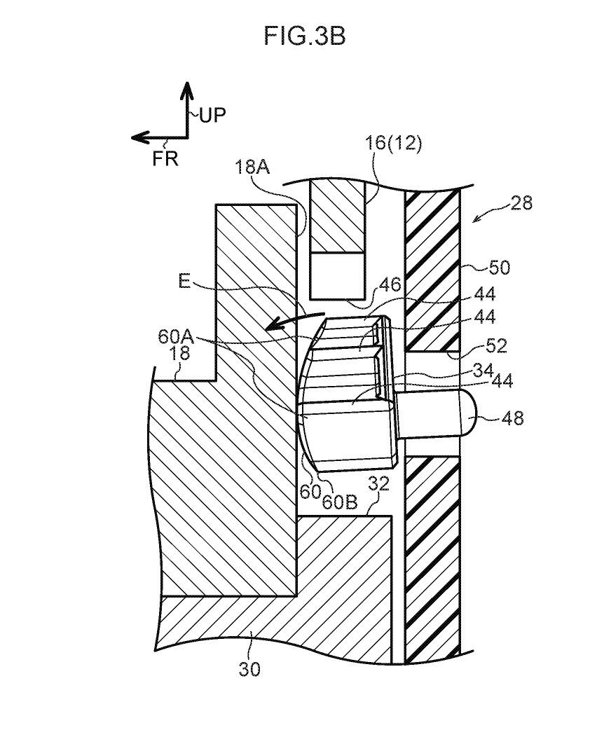

Substantially the entire vehicle front-side surface of the locking plate 34 forms a curved surface portion 60. The curved surface portion 60 is curved such that an inner side thereof bulges towards the vehicle front side beyond an outer peripheral edge of the vehicle front-side surface of the locking plate 34. As is shown in FIG. 3A, in the locking plate 34, a portion of the curved surface portion 60 that is furthest to the vehicle front side is in contact with a vehicle rear-side surface 18A of the spool 18, with this vehicle rear-side surface 18A serving as a seating surface which is an aspect of a sliding contact surface.

Furthermore, a portion of the curved surface portion 60 of the locking plate 34 that is furthest to the vehicle front side is set further toward an opposite side (i.e., on a side in the direction indicated by an arrow D in FIG. 2) from the locking side than a locking side edge portion 60A of an edge portion on the vehicle front side of each locking tooth 44 of the locking plate 34. Moreover, the portion of the curved surface portion 60 that is furthest to the vehicle front side is also set further toward the locking side than an anti-locking side edge portion 60B which is on an opposite side from a locking side of the outer peripheral edge of the vehicle front-side surface of the locking plate 34.

Because of this, as is shown in FIG. 3A, when the portion of the curved surface portion 60 of the locking plate 34 that is furthest to the vehicle front side is in contact with the vehicle rear-side surface 18A of the spool 18, the locking side edge portion 60A of each locking tooth 44 shown in FIG. 2 is provided further toward the vehicle rear side than the vehicle rear-side surface 18A of the spool 18, and the anti-locking side edge portion 60B of the locking plate 34 is also provided further toward the vehicle rear side than the vehicle rear-side surface 18A of the spool 18.

In addition, a distal end of each locking tooth 44 has a certain amount of thickness in the vehicle front-rear direction, and the distal end of each locking tooth 44 and the ratchet teeth of the ratchet hole 46 in the leg plate 16 face each other in the radial direction of the spool 18. As a consequence of this, in spite of the vehicle front-side surface of the locking plate 34 being formed as the curved surface portion 60, the distal ends of the respective locking teeth 44 are able to intermesh with the ratchet teeth of the ratchet hole 46 in the leg plate 16.

### Actions and Effects of the Present Exemplary Embodiment

Next, actions and effects of the present exemplary embodiment will be described.

In the present webbing take-up device 10, if the vehicle suddenly decelerates in the event of a vehicle emergency such as a vehicle collision or the like, the VSIR mechanism 56 of the locking mechanism 28 is operated. Moreover, if the body of a vehicle occupant performs an inertial movement towards the vehicle front side during the vehicle emergency, the webbing 20 that has been drawn across the body of the vehicle occupant is pulled. As a result, the locking base 30 is rotated in the pull-out direction together with the spool 18 and, furthermore, the V gear 50 is also rotated in the pull-out direction following the locking base 30. If the rotational acceleration of the V gear 50 in the pull-out direction exceeds a predetermined size, then the WSIR mechanism 58 of the locking mechanism 28 is operated.

In case in which the VSIR mechanism 56 or the WSIR mechanism 58 is operated, rotation of the V gear 50 of the locking mechanism 28 in the pull-out direction is restricted. If, in this state, the webbing 20 is pulled out further so that the locking base 30 is rotated in the pull-out direction together with the spool 18, then the locking base 30 performs a relative rotation in the pull-out direction relative to the V gear 50. In the event that the locking base 30 is rotated in the pull-out direction relative to the V gear 50, the guide pin 48 of the locking plate 34 receives a load from an internal side surface of the guide hole 52 in the V gear 50 and, as a result of this, the locking plate 34 is pivoted towards the locking side around the supporting pin 42.

When the locking plate 34 is pivoted towards the locking side, the locking teeth 44 of the locking plate 34 are moved close to the ratchet teeth of the ratchet hole 46 in the leg plate 16, and the locking teeth 44 intermesh with the ratchet teeth of the ratchet hole 46 in the leg plate 16. As a result, rotation of the locking base 30 in the pull-out direction is restricted, and rotation of the spool 18 in the pull-out direction is also restricted. In this way, because the pulling out of the webbing 20 from the spool 18 is restricted as a result of the rotation of the spool 18 in the pull-out direction being restricted, the body of the vehicle occupant can be effectively restrained by the webbing 20.

In the event that the locking base 30 performs a relative rotation in the pull-out direction relative to the V gear 50, the guide pin 48 of the locking plate 34 that receives a load from the internal side surface of the guide hole 52 of the V gear 50 is provided on the vehicle rear side of the locking plate 34. In contrast to this, when the locking plate 34 is pivoted towards the locking side, friction resistance is generated between the curved surface portion 60, which is the vehicle front-side surface of the locking plate 34, and the vehicle rear-side surface 18A of the spool 18. Because of this, when the guide pin 48 receives the load from the internal side surface of the guide hole 52 of the V gear 50 so that the locking plate 34 is pivoted towards the locking side, as is shown in FIG. 3B, the locking plate 34 may become tilted in the direction indicated by an arrow E in FIG. 3B.

Here, the vehicle front-side surface of the locking plate 34 forms the curved surface portion 60 that bulges towards the vehicle front side, and the locking plate 34 comes into contact with the vehicle rear-side surface 18A of the spool 18 via the portion of the curved surface 60 that is furthest to the vehicle front side. Because of this, in a state prior to the locking plate 34 being pivoted towards the locking side, the locking side edge portion 60A of the edge portion on the vehicle front side of each locking tooth 44 is located further toward the vehicle rear side than the vehicle rear side surface 18A of the spool 18.

As a consequence of this, when the locking plate 34 is tilted in the direction indicated by the arrow E in FIG. 3B as a result of the locking plate 34 being pivoted around the supporting pin 42 towards the locking side, the locking side edge portion 60A of each locking tooth 44 is either prevented or inhibited from coming into contact with the vehicle rear-side surface 18A of the spool 18. As a consequence, friction resistance between the locking plate 34 and the vehicle rear-side surface 18A of the spool 18 can be inhibited from increasing, and the locking plate 34 can pivot smoothly towards the locking side.

In addition, when the outer peripheral edge of the vehicle front-side surface of the locking plate 34 comes into contact with the vehicle rear-side surface 18A of the spool 18, resistance to the pivoting of the locking plate 34 towards the locking side increases. Here, in the present exemplary embodiment, as is described above, in a state prior to the locking plate 34 being pivoted towards the locking side, the locking side edge portion 60A of each locking tooth 44 is located further toward the vehicle rear side than the vehicle rear side surface 18A of the spool 18.

Because of this, when the locking plate 34 begins to pivot towards the locking side, the locking side edge portion 60A of each locking tooth 44 does not come into contact with the vehicle rear side surface 18A of the spool 18. As a consequence of this, friction resistance between the locking plate 34 and the vehicle rear-side surface 18A of the spool 18 can be inhibited from increasing. As a result, the locking plate 34 is inhibited from tilting when this locking plate 34 is being pivoted, and any contact between the locking side edge portion 60A of each locking tooth 44 and the vehicle rear-side surface 18A of the spool 18 that might be generated by such a tilting of the locking plate 34 can be effectively prevented or inhibited.

Moreover, as is shown in FIG. 2, if the tail portion 36 of the locking plate 34 is sandwiched between the opposing wall 38A of the tail portion placement portion 38 and the vehicle rear-side surface 18A of the spool 18, so that a tilt of a predetermined angle or greater in the vehicle front-rear direction is generated at the locking plate 34, then the tail portion 36 of the locking plate 34 comes into contact with the opposing wall 38A of the tail portion placement portion 38 of the locking base 30. Because tilting of the locking plate 34 is inhibited, it is possible to effectively prevent or inhibit the locking side edge portion 60A of each locking tooth 44 from being brought into contact with the vehicle rear-side surface 18A of the spool 18 due to tilting of the locking plate 34.

At the same time, the curved surface portion 60, which is the vehicle front-side surface of the locking plate 34, bulges towards the vehicle front side. Because of this, the anti-locking side edge portion 60B, which is on the opposite side from the locking side, of the outer peripheral edge of the vehicle front-side surface of the locking plate 34 is positioned on the vehicle rear side of the portion of the curved surface portion 60 that is located furthest to the vehicle front side.

Because of this, when the locking plate 34 that has been pivoted to the locking side is restored by being pivoted towards the opposite side from the locking side, the anti-locking side edge portion 60B of the locking plate 34 can be prevented or inhibited from coming into contact with the vehicle rear-side surface 18A of the spool 18. As a result, when the locking plate 34 is restored by being pivoted towards the opposite side from the locking side, tilting of the locking plate 34 (for example, tilting of the locking plate 34 in the opposite direction from the direction indicated by the arrow E in FIG. 3B) can be inhibited. Because of this, friction resistance between the locking plate 34 and the vehicle rear-side surface 18A of the spool 18 can be inhibited from increasing, so that the locking plate 34 is able to pivot smoothly towards the opposite side from the locking side.

Note that, in the present exemplary embodiment, a structure is employed in which the vehicle rear-side surface 18A of the spool 18 is a sliding contact surface, and the curved surface portion 60 of the locking plate 34 comes into contact with this vehicle rear-side surface 18A of the spool 18. However, it is also possible for the sliding contact surface with which the curved surface portion 60 of the locking plate 34 comes into contact to be set at the locking base 30, or at a different component from both the locking base 30 and the spool 18.

Furthermore, in the present exemplary embodiment, a structure is employed in which the curved surface portion 60 is set on the vehicle front-side surface of the locking plate 34 , however, it is also possible, for example, for a curved surface portion to be set at a vehicle rear-side surface of the tail portion 36, and for a vehicle front-side surface of the opposing wall 38A of the tail portion placement portion 38 to be formed as a sliding contact surface, and for this curved surface portion on the vehicle rear-side surface of the tail portion 36 to slide over the vehicle front-side surface of the opposing wall 38A of the tail portion placement portion 38 of the locking base 30.

In a structure such as this, if a tilting action is generated in the locking plate 34, then the outer peripheral edge of the tail portion 36 of the locking plate 34 comes into contact with the vehicle front-side surface of the opposing wall 38A of the tail portion placement portion 38 and, as a result of this, friction resistance between the tail portion 36 of the locking plate 34 and the opposing wall 38A of the tail portion placement portion 38 to be prevented or inhibited from increasing. In this way, the curved surface portion set at the locking plate 34 is not limited to being set at the vehicle front-side surface (i.e., the surface on the spool 18 side) of the locking plate 34, and the curved surface portion may be set at the surface over which the locking plate 34 slides when the locking plate 34 is being pivoted (i.e., moved).

Moreover, in the present exemplary embodiment, a structure is employed in which the locking plate 34, which is serving as a locking component, is provided at the locking base 30. However, the location where the locking component is provided is not particularly limited, and it is also possible to employ a structure in which a locking component provided at the frame 12 is moved in such a way that this locking component is engaged with the locking base 30 so as to thereby restrict rotation of the spool 18 in the pull-out direction.

Furthermore, in the present exemplary embodiment, a structure is employed in which the entire vehicle front-side surface of the locking plate 34 is used to form the curved surface portion 60. However, it is also possible to employ a structure in which, for example, the curved surface portion 60 is set in a portion of the vehicle front-side surface of the locking plate 34 that is at an inner side of the outer peripheral edge. In other words, it is also possible to form the curved surface portion 60 such that, when the portion of the curved surface 60 that is positioned furthest to the vehicle front side is in contact with the vehicle rear-side surface 18A of the spool 18, which is serving as a sliding contact surface, at least a locking-side portion of the outer peripheral edge of the vehicle front-side surface of the locking plate 34 is located further toward the vehicle rear side than the vehicle rear-side surface 18A of the spool 18.

Priority is claimed on Japanese Patent Application No. 2016-158951, the disclosure of which is incorporated herein by reference.

All references, patent applications and technical specifications cited in the present specification are incorporated by reference into the present specification to the same extent as if the individual references, patent applications and technical specifications were specifically and individually recited as being incorporated by reference.

1. A webbing take-up device comprising:
a spool that is rotated in a pull-out direction as a result of a webbing of a seatbelt device being pulled out;
a sliding contact surface that is provided at a side, in a rotation axis direction, of the spool; and
a locking component that, as a result of the locking component being moved towards a locking side, causes rotation of the spool in the pull-out direction to be restricted, a curved surface portion that bulges towards a sliding contact surface side being provided at an inner side from an outer peripheral edge side at the sliding contact surface side of the locking component, and the curved surface portion being made to slide across the sliding contact surface by the movement of the locking component towards the locking side.

2. The webbing take-up device according to claim 1, wherein the curved surface portion is provided further toward the inner side of the locking component than a portion at the locking side of an outer peripheral edge at the sliding contact surface side of the locking component.

3. The webbing take-up device according to claim 1, further comprising an engaging component at which are formed engaging teeth with which locking teeth that are formed at the locking component intermesh as a result of the movement of the locking component towards the locking side, rotation of the spool in the pull-out direction being restricted by the locking teeth intermeshing with the engaging teeth,
wherein the curved surface portion is provided further toward the inner side of the locking component than a portion of the locking teeth that is set at an outer peripheral edge at the sliding contact surface side of the locking component.

4. The webbing take-up device according to claim 1, wherein a tilt inhibiting portion is disposed at the locking component at an opposite side, in the spool rotation axis direction, from the sliding contact surface, the locking component is sandwiched between the tilt inhibiting portion and the sliding contact surface, and in a case in which a tilt action is generated at the locking component, the locking component comes into contact with the tilt inhibiting portion so that tilting of the locking component is inhibited.

5. The webbing take-up device according to claim 4, wherein the locking component is moved towards the locking side as a result of the locking component receiving a load at a tilt inhibiting portion side on an opposite side from the curved surface side.
